(19) United States
(12) Patent Application Publication
(10) Pub. No.: US 2025/0337901 A1
(43) Pub. Date: Oct. 30, 2025

(54) 3D SWIN TRANSFORMER WITH SORTED GROUPING FOR POINT CLOUD COMPRESSION

(71) Applicant: InterDigital VC Holdings, Inc., Wilmington, DE (US)

(72) Inventors: Muhammad Asad LODHI, New York, NY (US); Jiahao PANG, New York, NY (US); Junghyun AHN, New York, NY (US); Dong TIAN, Wilmington, DE (US)

(21) Appl. No.: 18/647,469

(22) Filed: Apr. 26, 2024

(51) Int. Cl. H04N 19/119; H04N 19/30; H04N 19/597; H04N 19/96

(52) U.S. Cl. CPC H04N 19/119; H04N 19/30; H04N 19/597; H04N 19/96

(57) ABSTRACT

In one implementation, a shifted-window transformer with sorted grouping is used for point cloud compression. The points are first sorted according to a specified order and then the sorted points are grouped into windows with an equal number of points. All resulting windows are operated upon by self-attention to obtain initial attention features, followed by shifting the windows and another self-attention. We utilize the proposed transformer for lossless compression of point clouds via the octree representation and lossy compression via feature coding. Downsampling can be used to obtain features at different resolutions, which can be combined in a multi-scale solution. In addition, in a hybrid approach, the features can be divided into two parts: one for the window attention and the other for convolutions. The same sorting strategy can be used throughout the proposed architecture, or the network can switch between different sorting strategies every few attention layers.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple ipad Pro 2020 and Intel RealSense LiDAR camera L515. With advances in sensing technologies, 3D point cloud data becomes more practical than ever and is expected to be an ultimate enabler in the applications discussed herein.

### SUMMARY

According to one embodiment, a method for decoding 3D data is presented, comprising: obtaining sorted point-wise features associated with said 3D data; grouping said point-wise features into windows according to a number of points to be contained in each window; performing self-attention in each window according to an attention mechanism to update said point-wise features; and decoding said 3D data based on said point-wise features.

According to another embodiment, a method for encoding 3D data is presented, comprising: obtaining points in said 3D data with associated point-wise features; sorting said points and associated point-wise features according to an order; grouping said sorted points with associated point-wise features into windows according to a number of points to be contained in each window; performing self-attention in each window according to an attention mechanism to update point-wise features; and encoding said 3D data based on said updated point-wise features.

According to another embodiment, an apparatus for decoding 3D data is presented, comprising one or more processors and at least one memory coupled to said one or more processors, wherein said one or more processors are configured to: obtain sorted point-wise features associated with said 3D data; group said point-wise features into windows according to a number of points to be contained in each window; perform self-attention in each window according to an attention mechanism to update said point-wise features; and decode said 3D data based on said point-wise features.

According to another embodiment, an apparatus for encoding 3D data is presented, comprising one or more processors and at least one memory coupled to said one or more processors, wherein said one or more processors are configured to: obtain points in said 3D data with associated point-wise features; sort said points and associated point-wise features according to an order; group said sorted points with associated point-wise features into windows according to a number of points to be contained in each window; perform self-attention in each window according to an attention mechanism to update point-wise features; and encode said 3D data based on said updated point-wise features.

One or more embodiments also provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding 3D data according to the methods described above.

One or more embodiments also provide a computer readable storage medium having stored thereon video data generated according to the methods described above. One or more embodiments also provide a method and apparatus for transmitting or receiving the video data generated according to the methods described above.

### BRIEF DESCRIPTION OF THE DRAWINGS

FIG. 1 illustrates a block diagram of a system within which aspects of the present embodiments may be implemented.

FIG. 2 illustrates voxel-based probability distribution prediction with CNN.

FIG. 3 illustrates voxel-based probability distribution prediction with Sparse CNN.

FIG. 4 illustrates point-based probability distribution prediction with Transformer.

FIG. 5 illustrates point-based probability distribution prediction with SwinTransformer.

FIG. 6A and FIG. 6B illustrate general lossless and lossy point cloud compression architectures, respectively.

FIG. 7 illustrates point-based probability distribution prediction with SortFormer (shifted window transformer with sorted grouping).

FIG. 8 illustrates an example of window division of the point cloud in the spatial domain.

FIG. 9 illustrates a SortFormer architecture, according to an embodiment.

FIG. 10 illustrates a multi-scale SortFormer architecture, according to an embodiment.

FIG. 11 illustrates a hybrid architecture for SortConvFormer, according to an embodiment.

FIG. 12 illustrates a diagram of a block-based lossy point cloud compression system, according to an embodiment.

FIG. 13 illustrates a single module within feature the enhancement and aggregation module, according to an embodiment.

FIG. 14 illustrates a diagram of a block-based lossless point cloud compression system.

### DETAILED DESCRIPTION

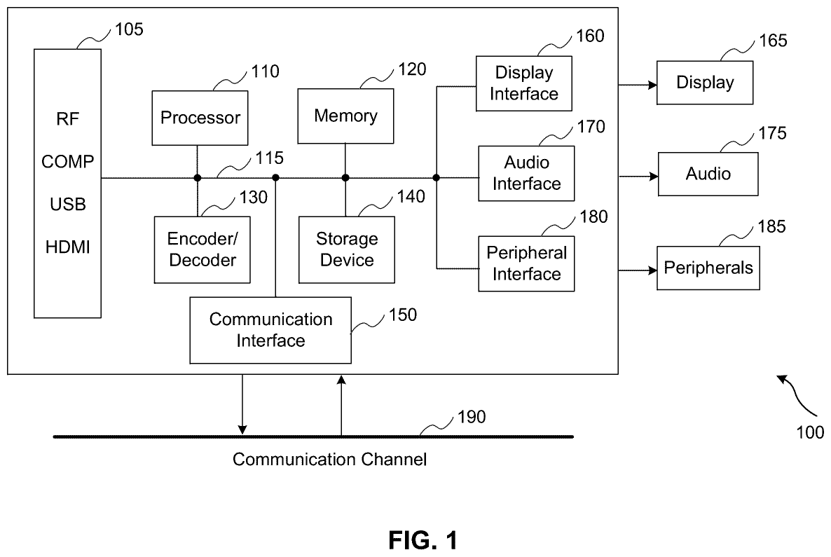

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802. 11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television.

In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different time. Dynamic point clouds may require the processing and compression to be in real-time or with low delay.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may be also used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power. It then becomes imperative to devise computationally and memory efficient learning-based architectures for 3D point clouds.

In order to perform processing or inference on a point cloud, efficient storage methodologies are needed. To store and process an input point cloud with affordable computational cost, one solution is to downsample the point cloud first, where the downsampled point cloud summarizes the geometry of the input point cloud while having much fewer points. The downsampled point cloud is then fed to the subsequent machine task for further consumption. However, further reduction in storage space can be achieved by converting the raw point cloud data (original or downsampled) into a bitstream through either entropy coding techniques for lossless compression or feature map coding techniques for lossy compression.

There are two main approaches to process the 3D point cloud data which is usually available as a list of 3D coordinates defining the locations of the 3D points in a 3D space. The voxel-based approach represents the point cloud as binary (occupied or unoccupied) cells in a 3D grid of a desired resolution. The point-based approach performs all processing on the raw point cloud data.

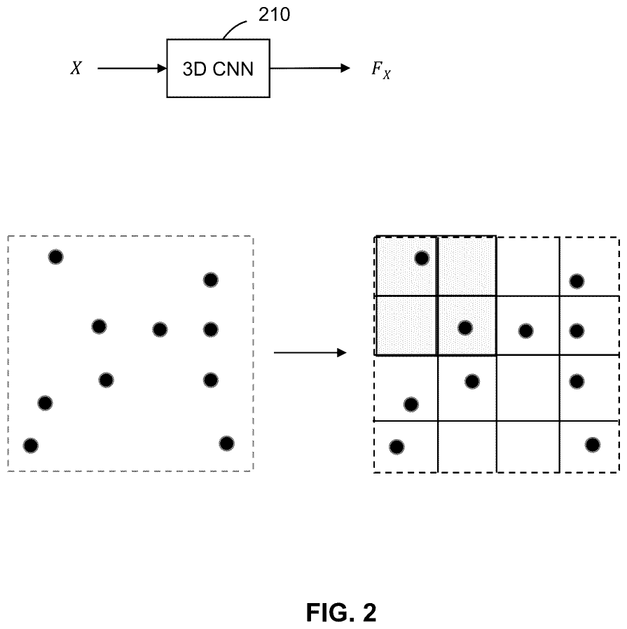

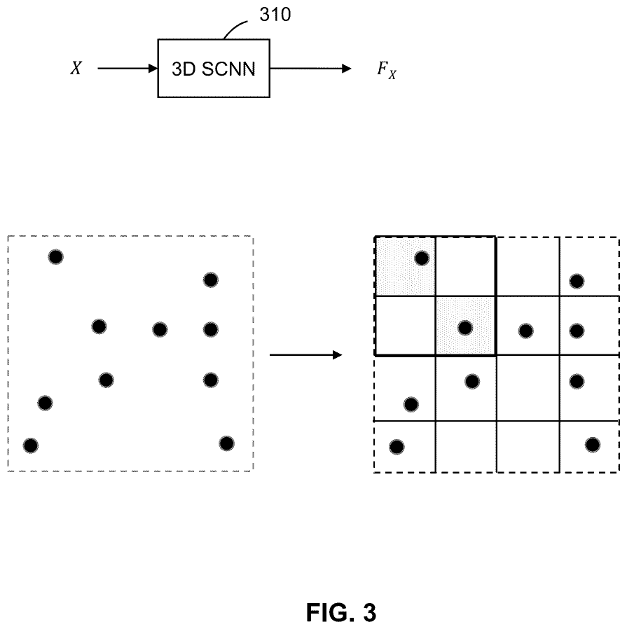

The voxel-based representation as illustrated in FIG. 2 can be seen as an extension of the traditional 2D image pixel representation and leverages 3D convolutions (210) for feature extraction for processing point cloud data. However, naive 3D convolutions are extremely inefficient as the voxel representation can have even fewer than 1% occupied voxels. Therefore, 3D sparse convolutions (310) were introduced, as shown in FIG. 3, which only compute the convolution kernel over the occupied cells in the voxel representation. However, with a convolution-based architecture the receptive field of the kernel can only be enlarged to a certain extent as the number of parameters for a 3D kernel of dimensions k×k×k scale exponentially (k³) with the dimensions.

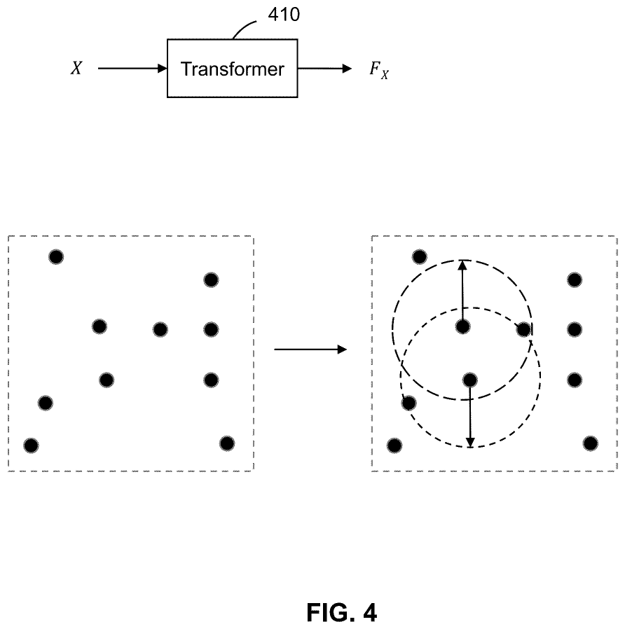

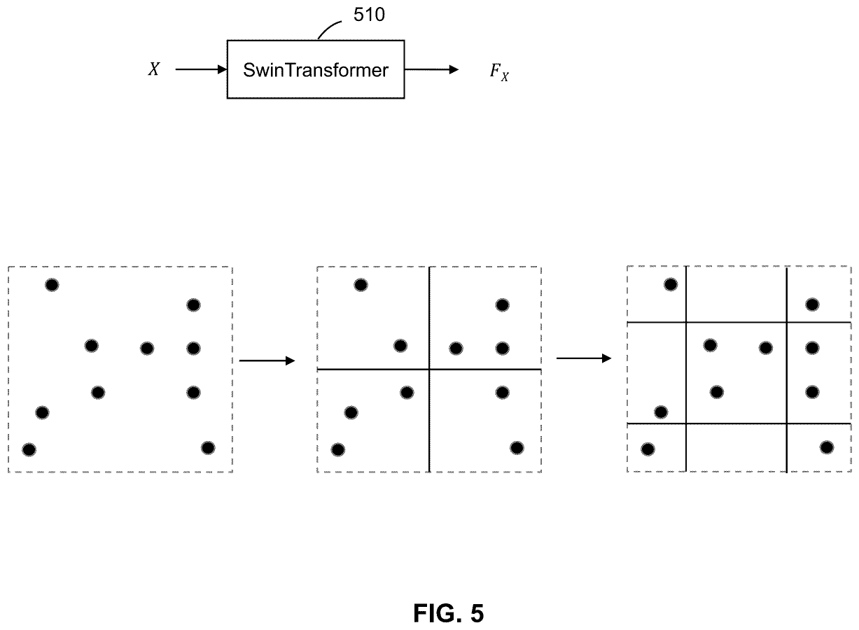

On the other hand, as illustrated in FIG. 4, the point-based approaches like PointNet or PointTransformer (410) can directly digest the raw point cloud using MLPs (Multi Layer Perceptrons) to generate pointwise features followed by a neighborhood search to identify neighboring points for feature aggregation via pooling (PointNet) or attention mechanisms (PointTransformer). The receptive field in point-based architectures can be increased without increasing the number of parameters by just increasing the neighborhood size. However, the neighborhood search in point-based methods can incur high computational and memory cost depending on the number of points in the point cloud and the size of the neighborhood (or number of neighbors chosen). To overcome this issue, Shifted-window (Swin) transformer (510) architecture, as illustrated in FIG. 5, was proposed which bypasses the neighborhood search by splitting the point cloud into several smaller windows followed by performing self-attention alternatingly over the original and shifted windows. However, one problem remaining with Swin transformer is that the number of points in windows vary significantly, namely, some windows can be very sparse (sometimes empty) and other very dense, causing the windows non-adaptable to point density and making the model performance worse. Our work focuses on resolving this problem in the Swin transformer architecture.

It should be noted here that works with similar motivation have appeared in the literature of point cloud processing and compression. However, most of the previous works have proposed the Swin transformer with sorted grouping for higher level tasks such as detection, segmentation, classification, etc., which only require coarse or class level features of the points or blocks of points. However, we propose to use the architecture for point cloud compression which is a much harder low-level task requiring very fine features. Additionally, for the case of spinning LiDAR point cloud compression, we propose a novel sorting strategy which is domain specific for spinning LiDAR data.

In the following, we provide the details of our proposed SortFormer architecture within the context of point cloud compression.

### SortFormer: Sorted Grouping Swin Transformer

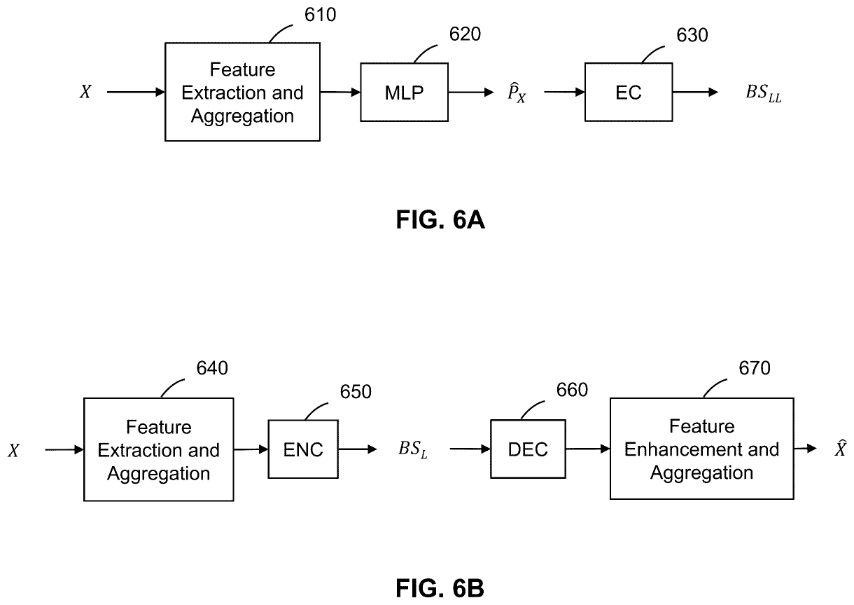

In one embodiment, FIG. 6A illustrates our proposed SortFormer module that can be used within a lossless compression architecture for the octree representation of a 3D point cloud via learned entropy coding (630). In this regard, the role of the proposed architecture is to predict the occupancy probability \hat{P}_{X} (bitwise coding) or occupancy symbol distribution (bytewise coding) for each node in the octree, based on a learned feature from a feature extraction and aggregation module (610) via an MLP (620). We choose to perform breadth-first traversal of the octree nodes which ensures that for each octree level, the whole parent level has already been encoded/decoded.

In another embodiment, FIG. 6B illustrates that our proposed SortFormer module can be used within a feature coding pipeline. In particular, a feature extraction and aggregation module (640) produces richer features being sent to the entropy bottleneck encoder (650), which encodes the quantized features into a bitstream. Likewise, on the decoder side, our proposed SortFormer module can also be used for feature enhancement and aggregation (670), after the quantized features are decoded from the entropy bottleneck decoder (660).

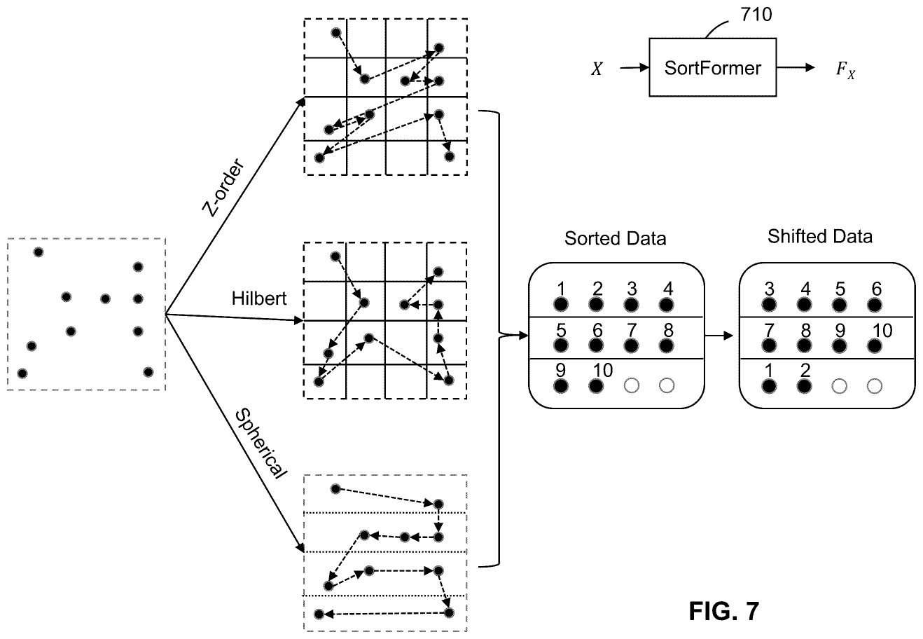

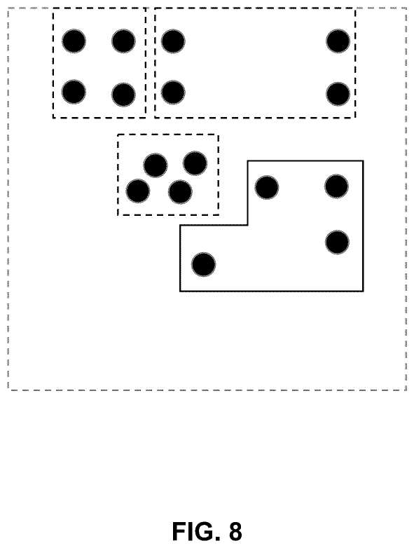

With focus on the octree coding, consider that at a particular octree level, we have a (quantized) version of the original point cloud. With this version of a point cloud, our proposed transformer (710) is shown in FIG. 7. Like the Swin Transformer, our proposed transformer also operates on shifted windows within a point cloud. However, all windows (except possibly one) have exactly the same number of points. Thus, the windows divide the whole point cloud non-uniformly in the spatial domain, as shown in an example in FIG. 8. This ensures that dense regions have smaller windows while sparse regions have larger windows. The number of points can depend on the use cases and availability memory. Note that the windows can be in very irregular shapes as shown in FIG. 8.

To perform this equal point window partitioning, the point cloud (at the current octree level) is first sorted according to a specified order. The purpose of this sorting is to keep nearby points in the same window. Several space-filling curves satisfy this criterion, e.g., Z-order curve, Hilbert curve, Peano curve, etc., although some might work better than the others depending on the content of the point clouds.

Since our proposal is a Swin Transformer, FIG. 7 also depicts an example of the shifted window. For this example, there are 10 points at the current octree level and the number of points in each window will be 4. According to the sorting order, the points are divided into three windows: (1, 2, 3, 4), (5, 6, 7, 8), and (9, 10, −, −), where the index indicates the sorting order index of a point. Then, after shifting by half window, three shifted windows are (3, 4, 5, 6), (7, 8, 9, 10) and (1, 2, −, −).

We also introduce a novel sorting strategy which is the spherical sorting, also shown in FIG. 7. For the spherical sorting, the cartesian coordinates are first converted to the spherical coordinates which are then sorted first according to the elevation followed by azimuth angles. This sorting strategy emulates the acquisition order of the spinning LiDAR and is particularly useful for compression of LiDAR data. Additionally, it can also be used for non-LiDAR data where it can provide a smooth traversal path through the scene/object points.

In one embodiment, the same sorting strategy is used throughout the proposed architecture. In another embodiment, the network can freely switch between different sorting strategies every few attention layers.

### Architecture Overview

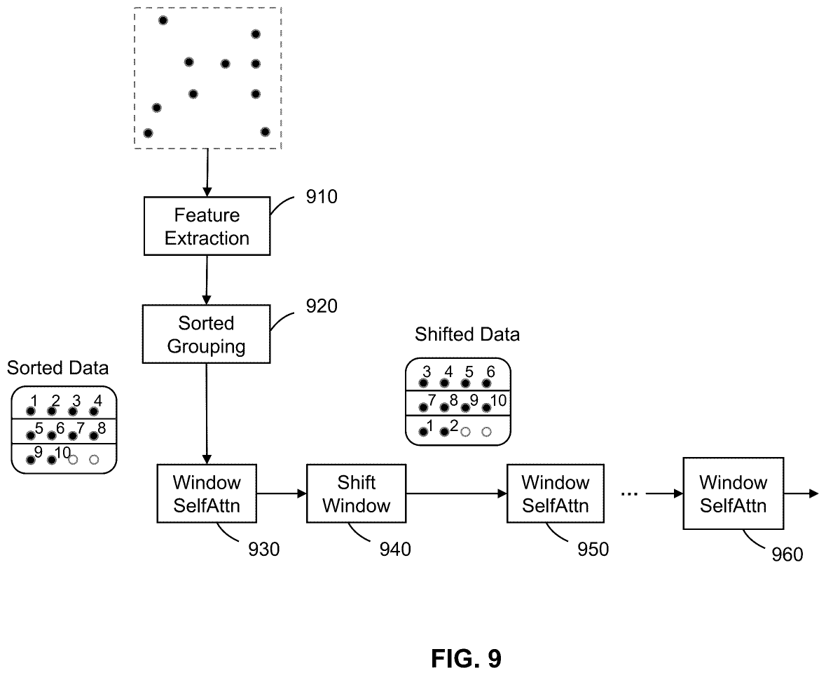

FIG. 9 illustrates the detailed operation of our single scale SortFormer, according to an embodiment. Initially, the point cloud at the current level goes through a general-purpose feature extractor (910) to produce an initial set of features. Then, the points along with their features undergo “sorted grouping” (920), where points are sorted according to the specified sorting strategy followed by grouping into windows with equal number of points. The windows with fewer points than the target number (if any) are padded to make all windows contain the same number of points. All resulting windows are operated upon by self-attention (930) to obtain initial attention features, followed by shifting the windows (940) (by a fraction of the window length) and another self-attention (950). This process is repeated several times (960) to refine the features, while a final MLP at the end converts the features into either node-wise occupancy probabilities for bitwise coding or node-wise occupancy symbol distribution for bytewise coding of each node of the octree representation of a point cloud. These probabilities can then directly be used by an arithmetic coder to encode (and decode) the nodes of an octree for lossless point cloud compression.

In one embodiment, the feature extractor (910) can be a simple MLP which operates individually on each point to produce an initial set of features. In another embodiment, the feature extractor can be naïve or sparse 3D convolutions. In yet another embodiment, the feature extraction can be performed using graph-based EdgeConv layers which utilize a nearest neighbor graph to extract and propagate features in the neighborhood of each node/point. In yet another embodiment, it can be replaced with more advanced convolution-based architectures like ResNets, Inception ResNets, etc.

### Multi-Scale SortFormer

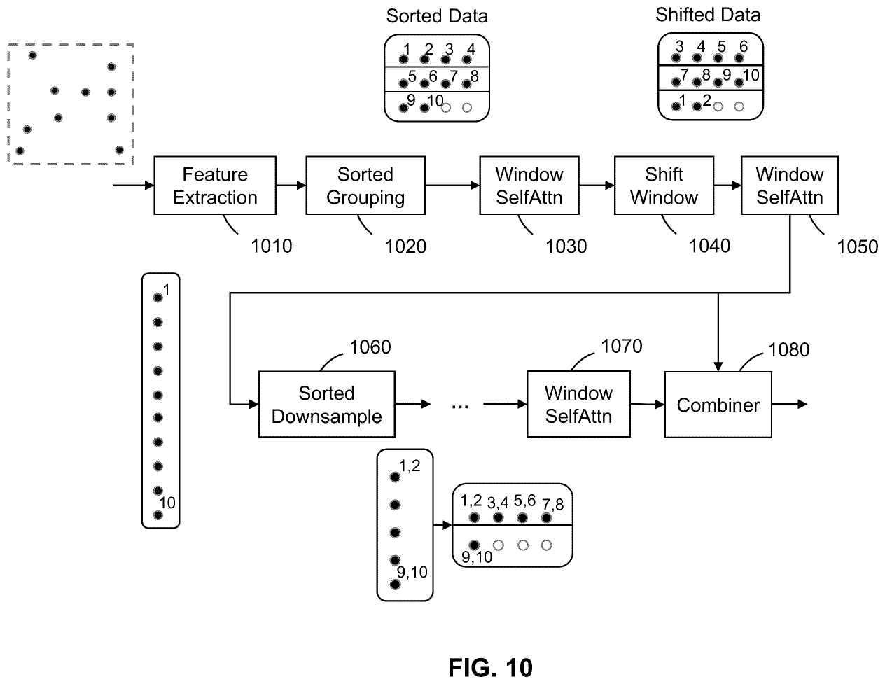

FIG. 10 illustrates a multi-scale SortFormer, according to an embodiment. After an initial set of features are extracted (1010) and undergoes “sorted grouping” (1020). Then, after a few attention and shifted-attention layers (1030, 1040, 1050) the points along with their features undergo “sorted downsample” (1060) where the points sorted according to the specified sorting strategy are downsampled. After the downsampling the points, which are already inherently sorted, undergo “sorted grouping” again to make windows followed by self-attention (1070). The process of downsampling can be repeated many times and at the end features from all scales of downsampling are combined (1080) with the initial features before downsampling. The combined features are then passed through the final MLP to produce either node-wise occupancy probabilities for bitwise coding or node-wise occupancy symbol distribution for bytewise coding.

In one embodiment, a 1D-convolution with stride equal to the downsampling factor is used to downsample the sorted points. In another embodiment, an adjacent number of points in the sorted list of points are adaptively merged into one point by concatenating all their features and mixing into a new single feature using an MLP.

In one embodiment, the combined features are made by adding the features from all scales. In yet another embodiment the combined features are made by concatenating the features from all scales.

### Attention Mechanisms

We use multi-head self-attention mechanism for all attention layers in our architecture. Many different versions of the attention mechanism exist in the literature. In one embodiment, the SoftMax attention mechanism

$${V}_{i}^{S}$$

can be used which is the traditional but most computationally expensive (quadratic complexity O(N²), where N is the number of nodes in the window) way of performing the attention mechanism.

$${V}_{i}^{S} = {\sum }_{j = 1}^{N} \frac{S ( {Q}_{i} , {K}_{j} )}{{\sum }_{k = 1}^{n} S ( {Q}_{i} , {K}_{k} )} {V}_{j}$$

where Qᵢ and Kⱼ are the input query and key features for the i-th and j-th points in the current window, S(Qᵢ, Kᵢ) is the Softmax function between the inner products of the respective features, and Vⱼ is the value features for the j-th point in the current window.

In another embodiment, linear attention

$${V}_{i}^{L}$$

can be used which incurs linear computational complexity instead of quadratic complexity for SoftMax attention.

$${V}_{i}^{L} = {\sum }_{j = 1}^{N} \frac{ϕ ( {Q}_{i} ) ϕ {( K {j}_{} )}^{T}}{{\sum }_{k = 1}^{n} ϕ ( {Q}_{i} ) {ϕ ( K {j}_{} )}^{T}} {V}_{j} = \frac{ϕ ( {Q}_{i} ) {\sum }_{j = 1}^{n} {ϕ ( K {j}_{} )}^{T} {V}_{j}}{ϕ ( {Q}_{i} ) {\sum }_{k = 1}^{n} {ϕ ( K {j}_{} )}^{T}}$$

where ϕ( ) is a specified linear kernel operating on features.

In yet another embodiment, the improved version of focused linear attention V^{F} can be used which also incurs linear complexity but exhibits improved performance as this formulation can focus the attention on similar features by pulling them closer to their nearest canonical axis through magnitude re-normalization fₚ(y).

$${V}^{F} = {ϕ}_{p} ( Q ) {{ϕ}_{p} ( K )}^{T} V + {GC}_{1 , H , K}^{H} ( V )$$

$${ϕ}_{p} = {f}_{p} ( RELU ( x ) ) ; {f}_{p} ( y ) = \frac{‖ y ‖}{‖ {y}^{p} ‖} {y}^{p}$$

Since the original focused linear attention was proposed for images, we propose a modified version of the focused linear attention where we use 1D depth-wise convolutions (grouped convolution with kernel size K and groups equal to the head dimension) for the sorted points in each window under each attention head.

### SortConvFormer: Hybrid Architecture

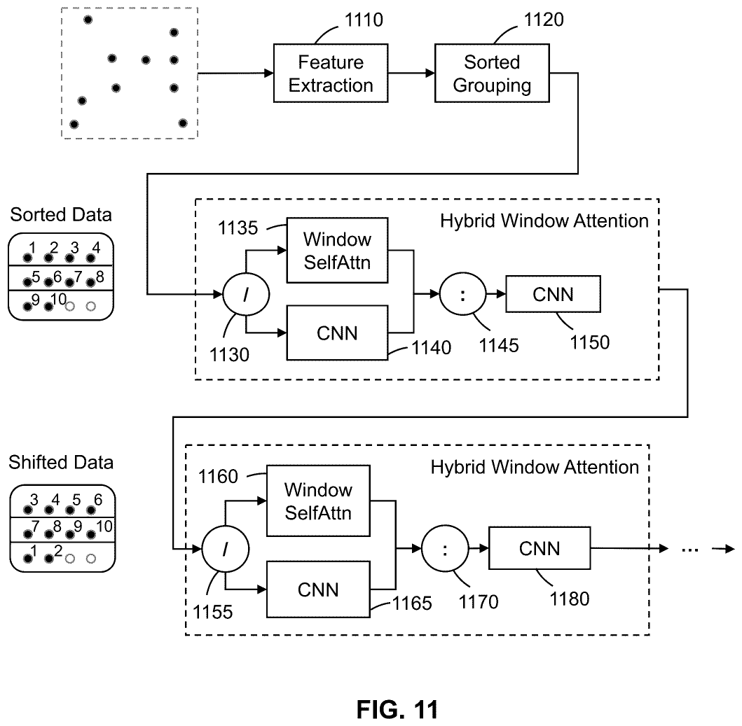

Transformers, like convolutions, lack any inductive bias which lets them outperform convolutions on large-scale datasets. However, for small- and moderate-scale datasets, convolutions can perform better than transformers owing to the inherent inductive bias. To achieve the best of both worlds, we propose a hybrid architecture transformer architecture as shown in FIG. 11. In the proposed hybrid window attention module the initial features (1110) after sorted grouping (1120) are split into two halves (1130) (can be equal or unequal): one for the window attention (1135) and the other for convolutions (1140). In one example, if the number of features is n, first n/2 features are one half and the second n/2 features are the second half. The split into two parts can also be based on another ratio.

After the updated features from the proposed window attention and convolutions branches are obtained, they are concatenated (1145) and further enhanced through another convolution module (1150). This architecture can make use of specialized features from attention and convolution, while operating at lower complexity because each parallel branch operates at half of the original feature dimensions. The hybrid window attention module can be repeated several times for feature aggregation. In one embodiment the CNN module (1140, 1165) can be composed of simple convolutions as shown in FIG. 11, while in other embodiments it can be replaced with more advanced convolution-based architectures like ResNets, Inception ResNets, etc.

Note the various architectures illustrated in FIGS. 9-11 can used for feature extraction and aggregation, for example, in modules 610 and 640.

### Block Based Coding

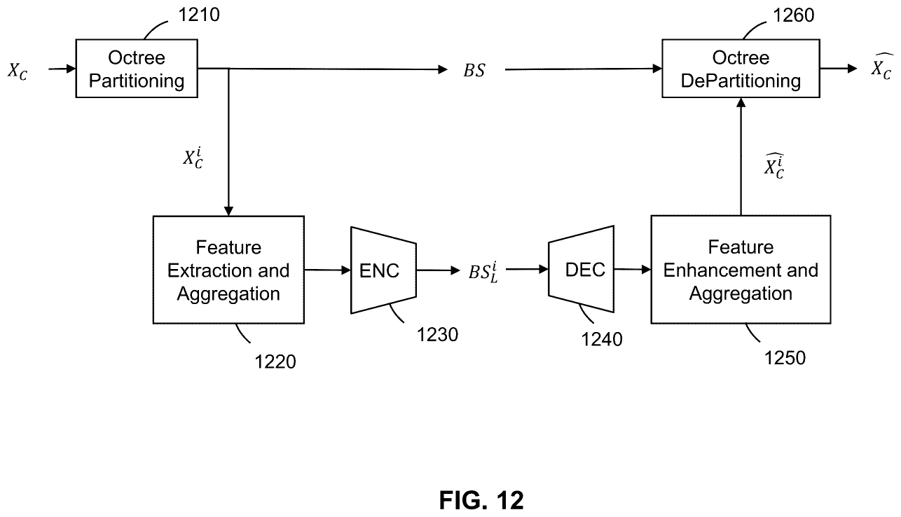

The description so far has been about the scenario when a whole point cloud (frame) is losslessly coded using the probabilities from the proposed SortFormer. However, in some cases it is desirable to first split the point cloud into several blocks, and then compress each block either losslessly or in a lossy manner. Encoding or decoding the whole point cloud frame can be seen as a special case where the whole frame is considered as a block. In one embodiment, as illustrated in FIG. 12, this can be achieved by first using a traditional or learning-based octree for partitioning the point cloud (1210), followed by lossy compression of features of each block obtained from the feature extraction and aggregation based on the proposed architecture (1220, 1230). Similarly, on the decoder side, the blocks can be decoded from their features using feature enhancement and aggregation (1240, 1250) based on the proposed architecture as described before in FIGS. 9-11. Finally, decoded blocks are combined with the partitioning information to perform octree de-partitioning (1260) to obtain the reconstructed point cloud. Here, octree partitioning is used, and other partitioning methods can also be used for partitioning the point cloud into blocks.

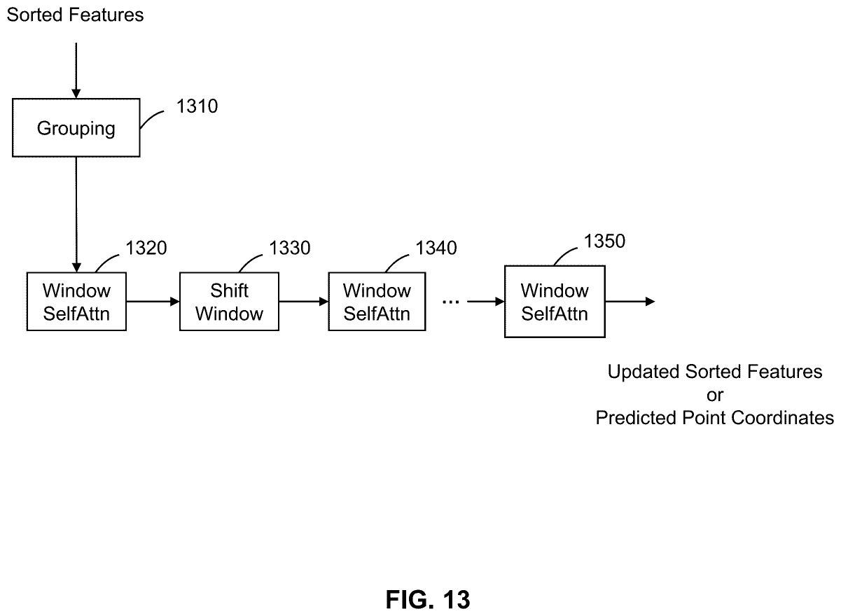

For feature enhancement and aggregation (1250) based on the proposed architecture, the initial point locations are not needed for sorting as the features sent from the encoder are already sorted. A single module (which can be repeated several times) within feature enhancement and aggregation is shown in FIG. 13. Grouping (1310) is performed directly on sorted features to make windows followed by window attention (1320) and shifted window attention (1330, 1340, 1350) several times (like in the previous cases). Moreover, depending on the output dimension of the module, the output can be features for a next module or final predicted point locations. Finally, the resolution of the final reconstructed points can be higher than the input features by having 3D sparse upsampling convolution modules between SortFormer modules, or by outputting multiple points corresponding to each feature in the last SortFormer module. Here, FIG. 13 corresponds to the architecture illustrated in FIG. 9 without the feature extraction and sorted grouping modules. In other examples, feature enhancement and aggregation (1250) can be performed with other architectures, for example, those illustrated in FIG. 10 or FIG. 11 without the feature extraction and sorted grouping modules.

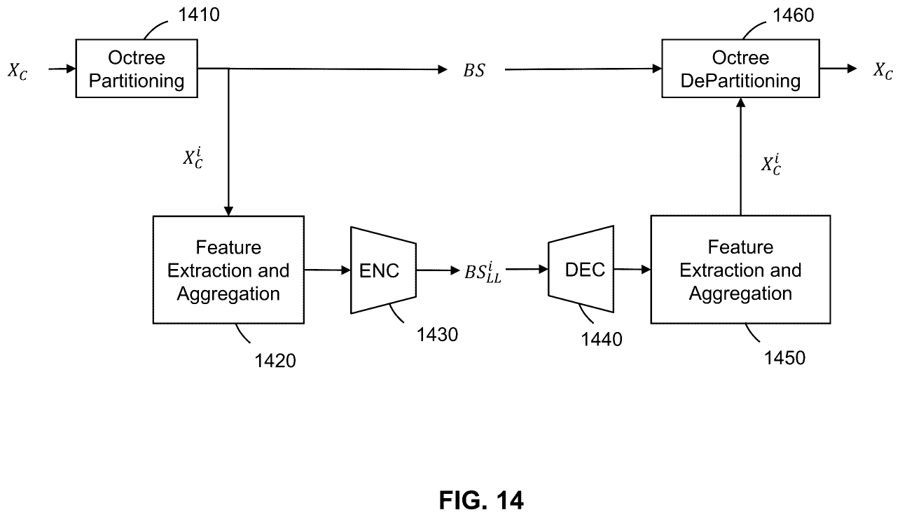

In another embodiment, as shown in FIG. 14, each block can be compressed losslessly via octree based lossless coding (as mentioned previously). On the encoder and decoder, probabilities required for lossless octree coding are always obtained (1420, 1450) based on the already coded nodes. Other modules (1410, 1430, 1440, 1460) would perform similarly as the corresponding modules in FIG. 12.

As described above, voxel-based methods for point cloud processing incur high number of network parameters when increasing the receptive field of the convolution-based architecture. Point-based methods can enjoy large receptive fields without increasing the number of parameters but can incur high computational cost. Shifted-window transformers alleviate the need to perform neighborhood search but create windows with imbalanced number of points. We propose a new shifted-window transformer with sorted grouping where the points are first sorted according to a specified order (application dependent) and then the sorted points are grouped into windows with equal number of points. This sorted grouping ensures that (1) points in each window have some sort of relevance to each other depending on the sorting method, and (2) that number of points in each window is balanced which inherently means that denser regions will make smaller spatial windows while sparser regions will constitute larger spatial windows. We utilize the proposed transformer for lossless compression of point clouds via the octree representation and lossy compression via feature coding.

While the above descriptions are based on point cloud data, when 3D meshes are to be compressed, the proposed methods can also be applied to locations of 3D meshes.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for decoding 3D data, comprising:
obtaining sorted point-wise features associated with said 3D data;
grouping said point-wise features into windows according to a number of points to be contained in each window;
performing self-attention in each window according to an attention mechanism to update said point-wise features; and
decoding said 3D data based on said point-wise features.

2. The method of claim 1, wherein said 3D data is losslessly decoded, further comprising:
obtaining previously decoded points in said 3D data with associated point-wise features;
sorting said decoded points and associated point-wise features according to an order, to obtain said sorted point-wise features; and
obtaining probabilities based on said updated point-wise features, wherein point locations of said 3D data are decoded based on said probabilities.

3. The method of claim 1, wherein said 3D data is lossy decoded, and wherein point locations of said 3D data are predicted from said updated point-wise features.

4. The method of claim 1, wherein said 3D data corresponds to point cloud data at a current octree level or location data of one or more 3D meshes.

5. The method of claim 1, wherein said point-wise features are sorted based on spherical sorting.

6. The method of claim 1, wherein an order for sorting said point-wise features is switched among a plurality of sorting methods.

7. The method of claim 1, wherein said self-attention is based on a focused linear attention where 1D depth-wise convolution is used under each attention head.

8. The method of claim 1, further comprising:
shifting said windows; and
performing self-attention in each shifted window according to said attention mechanism, wherein said features are further updated.

9. The method of claim 8, further comprising:
downsampling said point-wise features;
performing grouping and self-attention to obtain features at a different resolution; and
combining said point-wise features with said features at said different resolution.

10. The method of claim 1, further comprising:
splitting said point-wise features into two parts in each window, wherein said self-attention is performed on a first part in a window according to said attention mechanism;
performing convolution-based feature aggregation on a second part in a window;
concatenating features from said self-attention and convolution-based feature aggregation; and
performing feature mixing through a convolution-based module.

11. A method for encoding 3D data, comprising:
obtaining points in said 3D data with associated point-wise features;
sorting said points and associated point-wise features according to an order;
grouping said sorted points with associated point-wise features into windows according to a number of points to be contained in each window;
performing self-attention in each window according to an attention mechanism to update point-wise features; and
encoding said 3D data based on said updated point-wise features.

12. The method of claim 11, wherein said encoding said 3D data is lossy, and wherein said updated point-wise features are encoded in a bitstream.

13. The method of claim 11, wherein said encoding said 3D data is lossless and comprising:
obtaining probabilities based on said updated point-wise features of previously coded points, wherein point locations of said 3D data are encoded based on said probabilities.

14. An apparatus for decoding 3D data, comprising one or more processors and at least one memory coupled to said one or more processors, wherein said one or more processors are configured to:
obtain sorted point-wise features associated with said 3D data;
group said point-wise features into windows according to a number of points to be contained in each window;
perform self-attention in each window according to an attention mechanism to update said point-wise features; and
decode said 3D data based on said point-wise features.

15. The apparatus of claim 14, wherein said 3D data is losslessly decoded, wherein said one or more processors are further configured to:
obtain previously decoded points in said 3D data with associated point-wise features;
sort said decoded points and associated point-wise features according to an order, to obtain said sorted point-wise features; and
obtain probabilities based on said updated point-wise features, wherein point locations of said 3D data are decoded based on said probabilities.

16. The apparatus of claim 14, wherein said 3D data is lossy decoded, and wherein point locations of said 3D data are predicted from said updated point-wise features.

17. The apparatus of claim 14, wherein said point-wise features are sorted based on spherical sorting.

18. An apparatus for encoding 3D data, comprising one or more processors and at least one memory coupled to said one or more processors, wherein said one or more processors are configured to:
obtain points in said 3D data with associated point-wise features;
sort said points and associated point-wise features according to an order;
group said sorted points with associated point-wise features into windows according to a number of points to be contained in each window;
perform self-attention in each window according to an attention mechanism to update point-wise features; and
encode said 3D data based on said updated point-wise features.

19. The apparatus of claim 18, wherein said encoding said 3D data is lossy, and wherein said updated point-wise features are encoded in a bitstream.

20. The apparatus of claim 18, wherein said encoding said 3D data is lossless and wherein said one or more processors are further configured to:
obtain probabilities based on said updated point-wise features of previously coded points, wherein point locations of said 3D data are encoded based on said probabilities.
